(19) United States
(12) Patent Application Publication
(10) Pub. No.: US 2005/0175074 A1
(43) Pub. Date: Aug. 11, 2005

(54) Wireless communication method and apparatus for performing multi-user detection using reduced length channel impulse responses

(75) Inventors: Jung-Lin Pan, Selden, NY (US); Donald M. Grieco, Manhassett, NY (US); Aykut Bultan, Bayside, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/010,720

(22) Filed: Dec. 13, 2004

Related U.S. Application Data
(60) Provisional application No. 60/544,416, filed on Feb. 11, 2004.

(51) Int. Cl. H04B 1/707

(52) U.S. Cl. 375/148

(57) ABSTRACT

Joint detection is performed in a multi-user detector (MUD) using reduced length channel impulse responses and using interference cancellation (IC) in the dimension of delay spread as a whole, whereby several clusters of smaller delay spread are processed. Several clusters of real transmitted paths that are close to each other are grouped together and zeros that occur between the path cluster groups are discarded. Each cluster group has a much shorter delay spread and thus has smaller dimensions of system matrix A. Mutual interference occurring between the path cluster groups is eliminated by applying an interference cancellation technique.

### CROSS REFERENCE TO RELATED APPLICATION

This application claims priority from U.S. Provisional Application No. 60/544,416, filed Feb. 11, 2004, which is incorporated by reference as if fully set forth herein.

### FIELD OF THE INVENTION

The present invention relates to the field of wireless communications. More specifically, the present invention relates to performing joint detection using reduced length channel impulse responses to reduce interference.

### BACKGROUND

A Multi-user detector (MUD) that uses joint detection is an excellent receiver for code division multiple access (CDMA) systems because it offers excellent performance as compared to other type of receivers, such as a matched filter (MF). However a joint detection based MUD has a high complexity that increases with the cube of dimensions of matrices that are used to implement MUD. A MUD includes an MF which typically dominates the overall complexity. A system matrix A is the heart of the MF and MUD, and has the dimension of Q×N_{S}+l−1 by K×N_{S}, where Q is the spreading factor, N_{S} is the number of data symbols to be demodulated, l is the total length of delay spread and K is the number of codes to be detected. l is usually larger than the number of real transmitted paths p. Typically, l can be as large as 64 and p can be as small as 4 in Time Division Duplex (TDD) systems.

When a typical MUD processes the entire l=64, there are a lot of zero elements being processed and thus the process has a high complexity. To overcome this drawback and to reduce the complexity, a new algorithm is desired that process the entire large delay spread l=64 in a more efficient manner.

A MUD using joint detection uses matched filter (MF) and matrix inverse processing. A received signal model for MUD problems can be expressed by:
\vec{r}=A\vec{d}+\vec{n}, Equation (1)
where the A is the system matrix, \vec{d} are the symbols to be detected, \vec{n} is the noise vector and \vec{r} is the received signal at the receiver site. A typical detection algorithm for MUD using joint detection is:
\vec{\hat{d}}=(A^{H}A)⁻¹A^{H}\vec{r} Equation (2)
for zero-forcing (ZF) block linear equalizer (BLE) and
\vec{\hat{d}}=(A^{H}A+σ²I)⁻¹A^{H}\vec{r} Equation (3)
for minimum mean square error (MMSE) BLE where \vec{d} are the symbols to be detected and σ² is the noise power or noise variance. The matrix inverse processing can be performed using many techniques, such as Cholesky decomposition using exact or approximate methods, or a fast Fourier transform (FFT) based approach. The MF processing can be performed either using time domain matched filtering or frequency domain FFT.

### SUMMARY

The present invention is used to perform joint detection using reduced length channel impulse responses and using interference cancellation (IC) in the dimension of delay spread as a whole, whereby several clusters of smaller delay spread are processed. The l=64 paths are grouped into several clusters of paths that are close to each other and zeros that occur between the path cluster groups are discarded. Each cluster group has a much shorter delay spread and thus has smaller dimensions of system matrix A. However, mutual interference occurs between the path cluster groups when joint detection is performed in each group individually. The present invention eliminates the mutual interference by applying an interference cancellation technique.

### BRIEF DESCRIPTION OF THE DRAWING(S)

A more detailed understanding of the invention may be had from the following description, given by way of example and to be understood in conjunction with the accompanying drawings wherein:

FIG. 1 is a block diagram of a multi-user detector using reduced length channel responses and temporal interference cancellation (TIC) in accordance with the present invention;

FIG. 2 illustrates an example of delay spreads processed by the multi-user detector of FIG. 1;

FIGS. 3A, 3B and 3C, taken together, are a flowchart of a process including method steps for performing multi-user detection using reduced length channel impulse responses and temporal interference cancellation in accordance with the present invention;

FIG. 4 illustrates construction of a system matrix A using reduced length channel responses for the n^{th} channel impulse response group \vec{h}ₙ; and

FIG. 5 illustrates construction of support of the first symbol block in a system matrix A using reduced length channel response for the n^{th} channel impulse response group \vec{h}ₙ.

### DETAILED DESCRIPTION OF THE PREFERRED EMBODIMENTS

The preferred embodiments will be described with reference to the drawing figures where like numerals represent like elements throughout.

The present invention may be implemented in a wireless transmit/receive unit (WTRU), a base station and a wireless communication system.

Hereafter, the terminology “WTRU” includes but is not limited to a user equipment (UE), a mobile station, a fixed or mobile subscriber unit, a pager, or any other type of device capable of operating in a wireless environment.

When referred to hereafter, the terminology “base station” includes but is not limited to a Node-B, a site controller, an access point or any other type of interfacing device in a wireless environment.

The features of the present invention may be incorporated into an integrated circuit (IC) or be configured in a circuit comprising a multitude of interconnecting components.

Assuming that the original channel impulse response is \vec{h}, when the delay spread of \vec{h} is considerably long, the joint detection has significantly high complexity. To reduce the complexity of joint detection, \vec{h} is divided into a plurality of channel impulse response groups, i.e., \vec{h}₁ and \vec{h}₂, where \vec{h}=[\vec{h}₁,\vec{h}₂]. Usually, there are gaps filled with zeros between the channel impulse response groups such that \vec{h}=[\vec{h}₁,\vec{0},\vec{h}₂]. In general, \vec{h} can be divided into N channel impulse response groups \vec{h}₁, . . . , \vec{h}_{N} depending on their power-delay profile and \vec{h}=[\vec{h}₁,\vec{h}₂, . . . , \vec{h}_{N}] or \vec{h}=[\vec{h}₁,\vec{0},\vec{h}₂,\vec{0}, . . . , \vec{h}_{N}]. However, there may not be any zero elements between some or all of the channel impulse response groups.

Let l be the length of \vec{h} and let lₙ be the length of \vec{h}ₙ, n=1,2, . . . , N where l is the length of delay spread of \vec{h}, and lₙ is the length of delay spread of \vec{h}ₙ. If the lengths of delay spread l and lₙ are counted from a first non-zero element to a last non-zero element in their channel impulse responses, the following condition is satisfied:

$${\sum }_{n = 1}^{N} {l}_{n} \leq l . \qquad Equation ( 4 )$$

The channel impulse response groups are ranked based on their power P. Assuming that the power of the channel impulse response groups \vec{h}₁, . . . , \vec{h}_{N} is ranked by Pₕ_{₁}≧ . . . ≧Pₕ_{_{N}}, joint detection may be performed using \vec{h}₁, and the contributions of channel responses from channel impulse response groups \vec{h}₂, . . . , \vec{h}_{N} may be ignored. This will degrade the performance of joint detection but significantly reduce its complexity. The data symbols corresponding to each delay spread group are obtained using Equations 2 and 3. For example, to obtain the estimates of data symbols for delay spread group 1, the equalization \vec{\hat{d}}=(A₁^{H}A₁+σ²I)⁻¹A₁^{H}\vec{r} is used for MMSE, where A₁ is the system matrix constructed using channel impulse response delay spread group 1, A₂ is the system matrix constructed using channel impulse response delay spread group 2, . . . , and A_{N} is the system matrix constructed using channel impulse response delay spread group N. After obtaining the data symbols of joint detection for \vec{h}₁, the interference introduced by \vec{h}₁ is constructed, whereby it is removed from the received signal \vec{r}. The same procedure is repeated for the remaining channel impulse response groups \vec{h}₂, . . . , \vec{h}_{N}, but this time joint detection is implemented with the second strongest impulse channel response group \vec{h}₂, and channel impulse response groups \vec{h}₃, . . . , \vec{h}_{N} are ignored. The demodulated data symbols are obtained using \vec{h}₂. The same procedure is repeated until \vec{h}_{N} is approached.

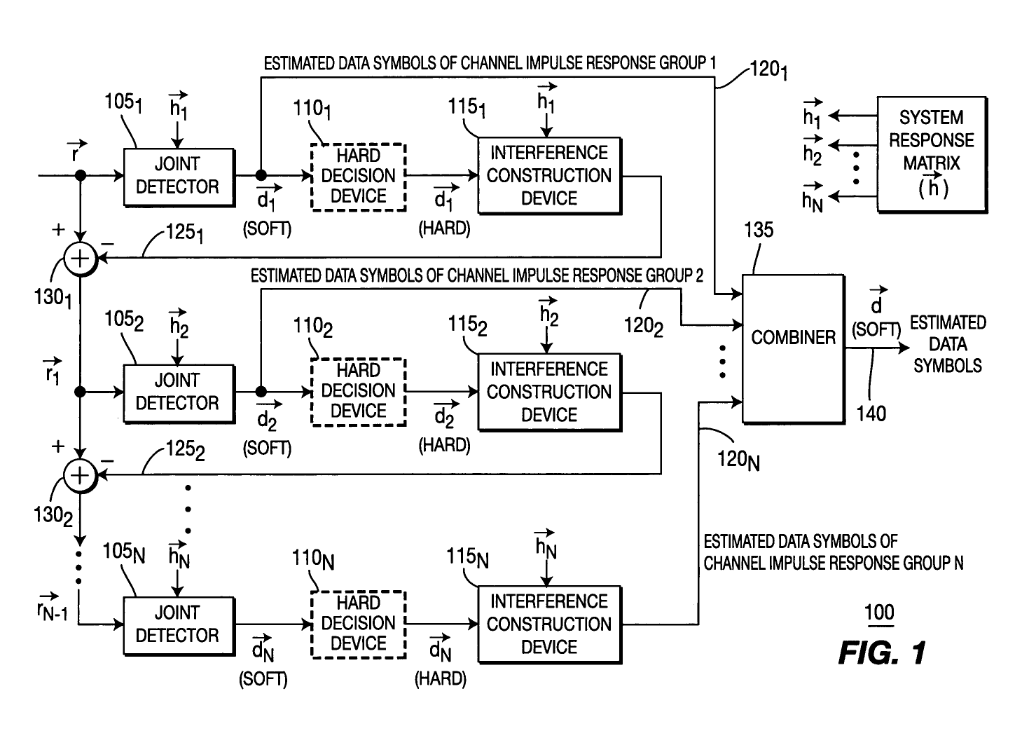

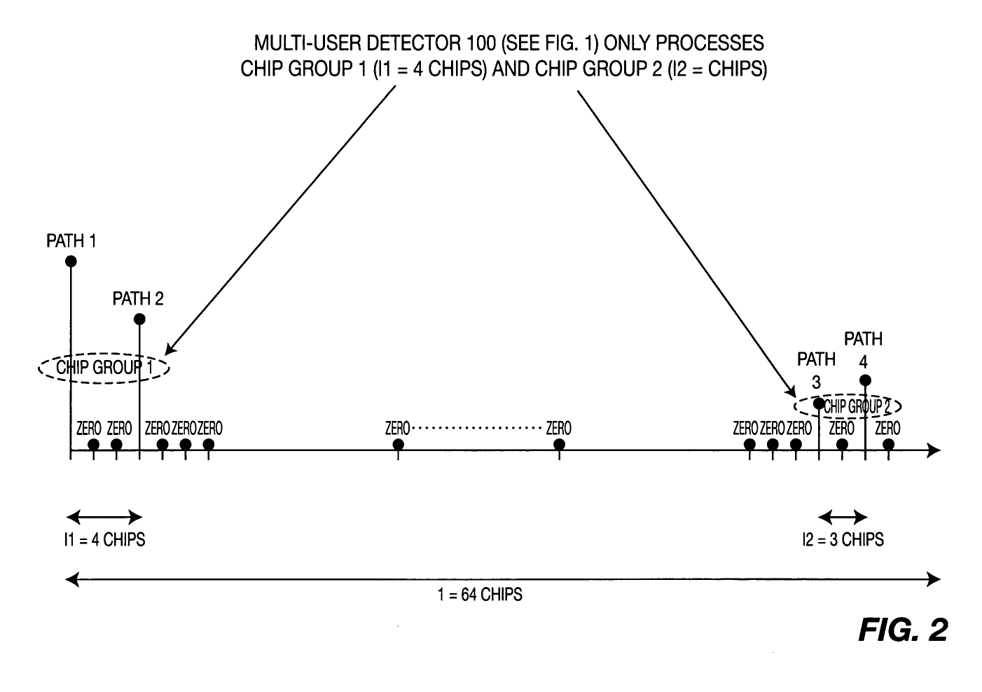

FIG. 1 shows the block diagram of multi-user detector 100 which uses reduced length channel responses and TIC in accordance with a preferred embodiment of the present invention. The multi-user detector 100 includes a system response matrix 102, a plurality of joint detectors 105₁, 105₂, . . . ,105_{N}, optional hard decision devices 110₁, 110₂, . . . ,110_{N}, interference construction devices 115₁, 115₂, . . . ,115_{N}, and adders 130₁, 130₂, . . . , and a combiner 135 which combines outputs 120₁, 120₂, . . . ,120_{N} of the joint detectors 105₁, 105₂, . . . ,105_{N} to provide an estimated data symbols output \vec{d} based on a plurality of channel impulse response groups 1-N. Signals which pass through the joint detectors 105, interference construction devices 115 and adders 130 must be time-aligned between the received signal, interference and the channel impulse responses. The system response matrix 102 provides an original channel impulse response (\vec{h}) with a long delay spread which is divided into a plurality of reduced length channel impulse response groups (\vec{h}₁, \vec{h}₂, . . . , \vec{h}_{N}).

The combiner 135 may be a maximum ratio combiner (MRC) or an equal gain combiner (EQC). Alternatively, a selection device may also be used.

The interference construction devices 115₁, 115₂, . . . ,115_{N} are used to regenerate the interference using the reduced length channel response for the n^{th} channel impulse response group \vec{h}ₙ. The estimated data symbols at the outputs of the joint detectors 105₁, 105₂, . . . ,105_{N} are denoted as \vec{d}ₙ. To perform the interference construction, the estimated data symbols are first spread with associated spreading codes for all codes to generate spread sequences, (i.e., signals after spreading), adding up the spread sequences to generate a composite chip sequence, (i.e., the signals consist of all of the spread sequences of codes), and convoluting the composite chip sequence with the corresponding channel impulse response \vec{h}ₙ. After performing the interference construction, the output 120_{N} of interference construction device 115_{N} is

$$( {\sum }_{k = 1}^{Kc} {\vec{d}}_{n}^{( k )} {\vec{c}}^{( k )} ) * {\vec{h}}_{n}$$

where \vec{d}ₙ^{(k)} is the estimated data symbols of the k^{th} spreading code of the outputs of the joint detectors 105₁, 105₂, . . . ,105_{N} using the channel impulse responses \vec{h}₁, \vec{h}₂, . . . , \vec{h}_{N}, where \vec{c}^{(k)} is the k^{th} spreading code.

The interference construction for the n^{th} channel impulse response group or delay spread group may be performed using the estimates of data symbols \vec{\hat{d}}ₙ of the nth channel delay spread group. Alternatively, the interference construction for the n^{th} channel impulse response group or delay spread group may also be performed using the estimates of all of the data symbols \vec{\hat{d}}₁, \vec{\hat{d}}₂, . . . , \vec{\hat{d}}ₙ of the nth channel delay spread group and the previous groups 1, 2, . . . , n−1. In this case, the “effective” estimated data symbols \vec{\hat{d}}_{n,eff} are used for interference construction instead of \vec{\hat{d}}ₙ for the nth channel delay spread group. The “effective” estimated data symbols \vec{\hat{d}}_{n,eff} can be obtained by combining, (using MRC or another combining method), the data symbols of the n^{th} channel delay spread group and the groups before n.

FIG. 2 shows an example of a power delay profile consisting of a 64 chips long delay spread with two clusters of delay spread, (i.e., channel impulse responses), “group 1” and “group 2.” While a conventional multi-user detector would process each of the 64 chips, the multi-user detector 100 shown in FIG. 1 only processes the channel impulse responses in group 1 (l1=4 chips) and group 2 (l2=3 chips). Thus, only 7 chips are processed, rather than the entire 64 chips.

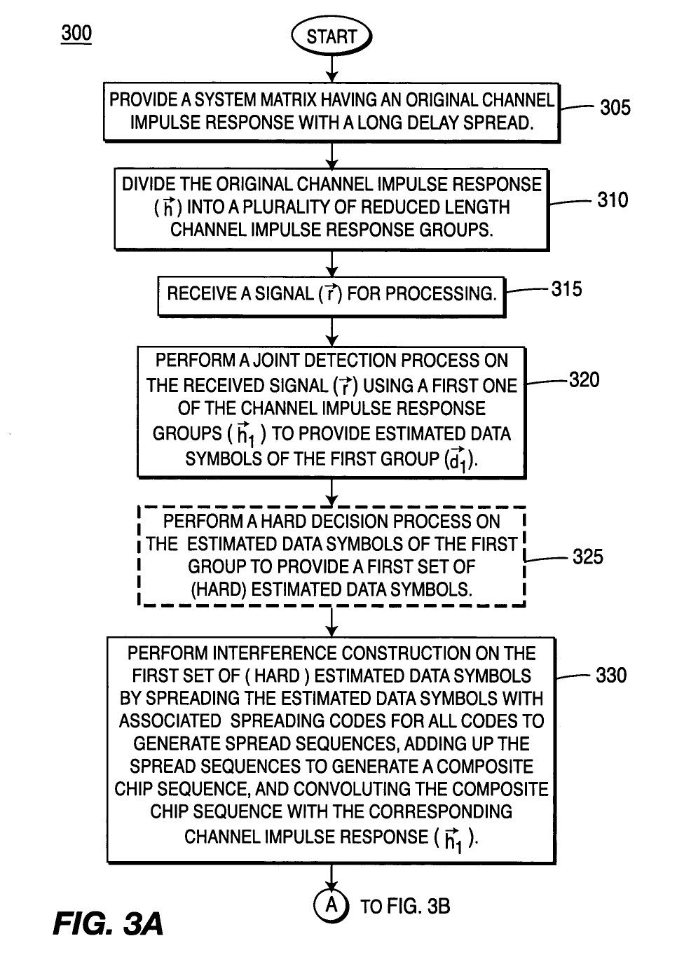

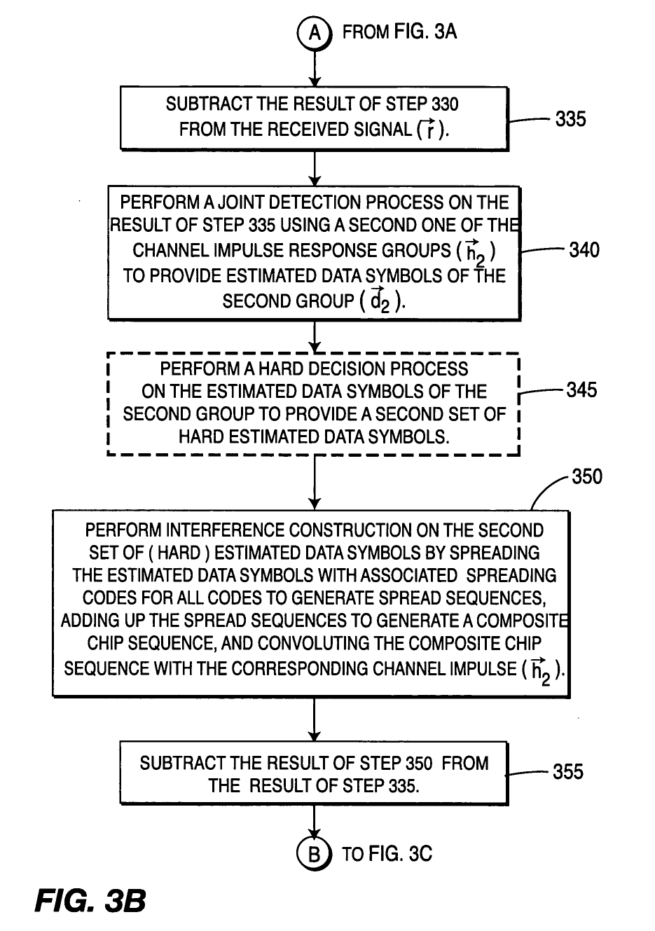

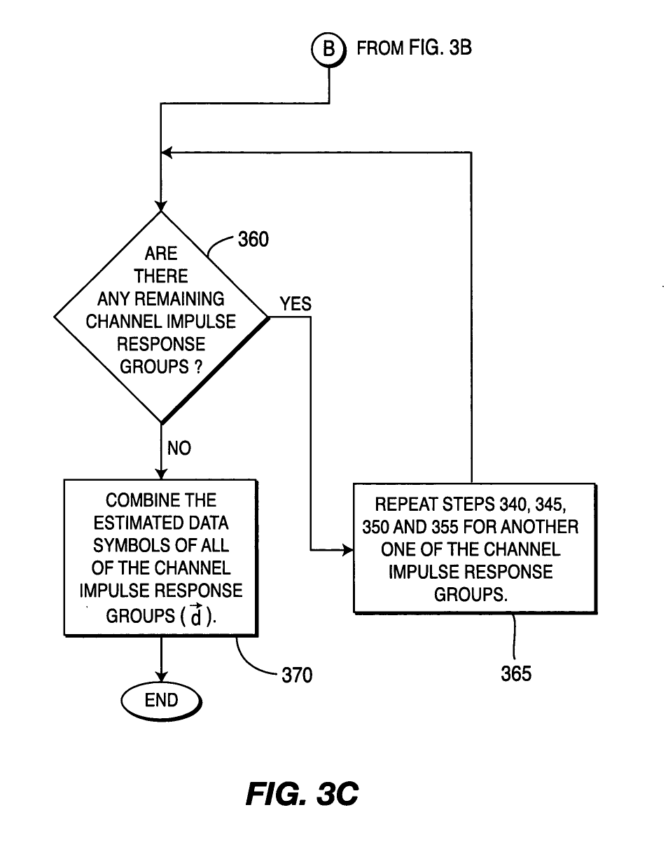

FIGS. 3A-3C, taken together, are a flowchart of a process 300 including method steps for performing multi-user detection using reduced length channel impulse responses and temporal interference cancellation. The term “temporal” refers to being limited by time, (i.e., the temporal dimension or time domain), whereby interference cancellation is performed in the temporal dimension instead of a code dimension. In step 305, a system response matrix 102 having an original channel impulse response (\vec{h}) with a long delay spread is provided. In step 310, the original channel impulse response (\vec{h}) is divided into a plurality of reduced length channel impulse response groups.

Referring to FIGS. 1 and 3A-3C, in step 315, a signal (\vec{r}) is received by the multi-user detector 100. In step 320, the joint detector 105₁ performs a joint detection process on the received signal \vec{r} using a first one of the channel impulse response groups (\vec{h}₁) to provide estimated data symbols of the first group (\vec{d}₁). In optional step 325, the hard decision device 110₁ performs a hard decision process on the estimated data symbols of the first group (\vec{d}₁) to provide a first set of hard estimated data symbols. In step 330, the interference construction device 115₁ performs interference construction on the first set of hard, (or soft if hard decision device 110₁ is not used), estimated data symbols by spreading the estimated data symbols with associated spreading codes for all codes to generate spread sequences, adding up the spread sequences to generate a composite chip sequence, and convoluting the composite chip sequence with the corresponding channel impulse response (\vec{h}₁). In step 335, the result of step 330, (i.e., the output of the interference construction device 115₁), is subtracted from the received signal \vec{r} using the adder 130₁.

Still referring to FIGS. 1 and 3A-3C, in step 340, the joint detector 105₂ performs a joint detection process on the result (\vec{r}₁) of step 335, (i.e., the output of the adder 130₁,) using a second one of the channel impulse response groups (\vec{h}₂) to provide estimated data symbols of the second group (\vec{d}₂). In optional step 345, the hard decision device 110₂ performs a hard decision process on the estimated data symbols of the second group (\vec{d}₂) to provide a second set of hard estimated data symbols. In step 350, the interference construction device 115₂ performs interference construction on the second set of hard, (or soft if hard decision device 110₂ is not used), estimated data symbols by spreading the estimated data symbols with associated spreading codes for all codes to generate spread sequences, adding up the spread sequences to generate a composite chip sequence, and convoluting the composite chip sequence with the corresponding channel impulse response (\vec{h}₂). In step 355, the result of step 350, (i.e., the output of the interference construction device 115₂), is subtracted from the result (\vec{r}₁) of step 335 using the adder 130₂. If, in step 360, it is determined whether or not there are any remaining channel impulse response groups to process. If so, steps 340, 345 (optional), 350 and 355 are repeated for another one of the remaining channel impulse response groups (step 365). If not, the estimated data symbols of all of the channel impulse response groups, (i.e., the outputs 120₁, 120₂, . . . ,120_{N} of the joint detectors 105₁, 105₂, . . . ,105_{N}), are combined to provide \vec{d} (step 370).

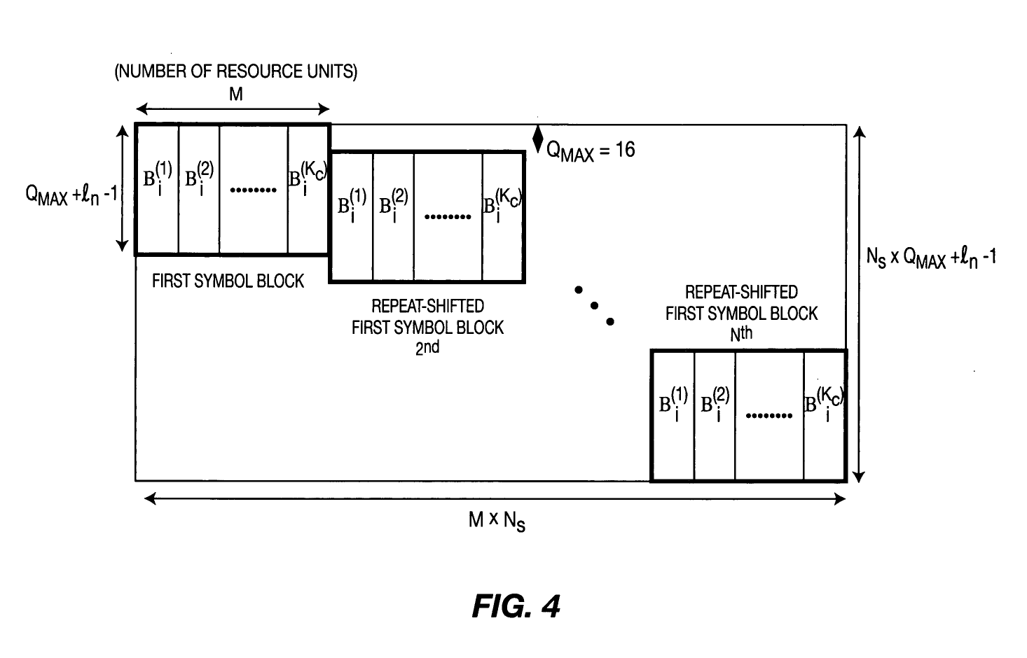

FIG. 4 shows the construction of a system matrix A using reduced length channel responses \vec{h}ₙ. To construct the system matrix A, the first symbol block └Bᵢ⁽¹⁾ Bᵢ⁽²⁾ . . . Bᵢ^{(K}^{_{c}}⁾┘ has to be constructed. K_{c} is the number of channelization codes. M is the number of resource units and Nₛ is the number of data symbols per spreading factor 16. To construct the entire system matrix A, the first symbol block is repeated and down shifted by Q_{MAX}, which is the maximum spreading factor of the system. For example, Q_{MAX}=16 for TDD or Time Division-Synchronous CDMA (TD-SCDMA) systems.

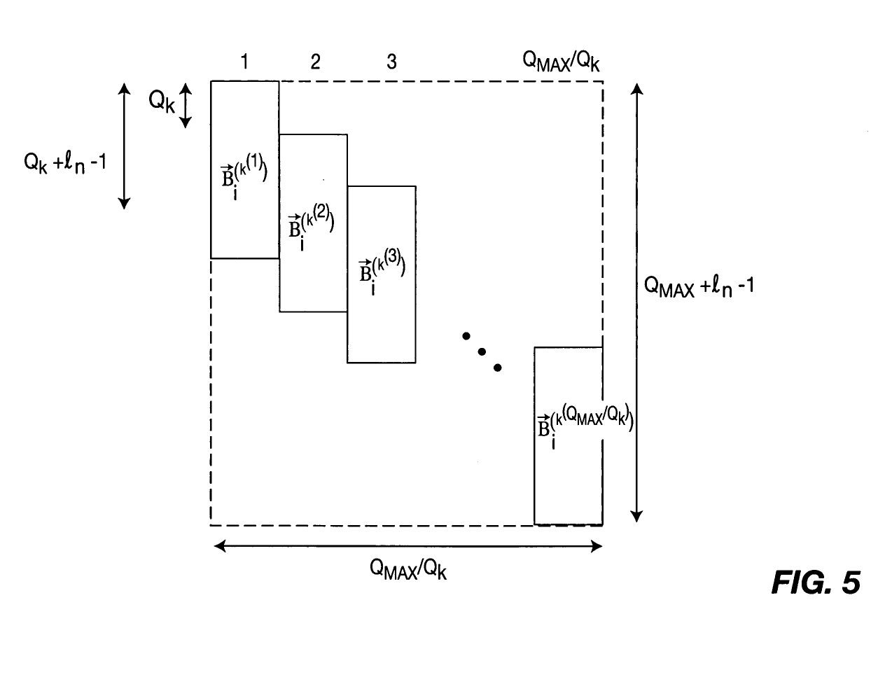

FIG. 5 shows the construction of support of the first symbol block in system matrix A for the reduced length channel response for the N^{th} channel implulse response group \vec{h}_{N}. Qₖ is the spreading factor of the k^{th} channelization code. For the k^{th} spreading code, the support has Q_{MAX}/Qₖ columns, which is equal to the number of resource units of the k^{th} spreading code.

In another embodiment, reduced length channel responses and maximum ratio combining may be used without making hard decisions or implementing interference construction. Signals which pass through the joint detectors must be time-aligned between the received signal the channel impulse responses. Alternatively, the present invention may be implemented without the use of the interference construction devices 115 for reduced complexity at the cost of performance degradation.

In yet another embodiment, parallel TIC (PTIC) may be implemented by performing the TIC in parallel for one or more desired channel impulse response groups such that interferences from all the other channel impulse response groups are cancelled from the desired channel impulse response group. This is similar to the parallel interference cancellation (PIC) in the code domain. However, the present invention applies PIC in the time domain.

While the present invention has been described in terms of the preferred embodiment, other variations which are within the scope of the invention as outlined in the claims below will be apparent to those skilled in the art.

1. In a code division multiple access (CDMA) system, a method of performing multi-user detection (MUD) using reduced length channel impulse responses, the method comprising:
(a) providing a system response matrix having an original channel impulse response with a long delay spread, wherein the original channel impulse response is divided into a plurality of reduced length channel impulse response groups;
(b) receiving a signal to be processed;
(c) performing a joint detection process on the received signal using a first one of the channel impulse response groups to provide estimated data symbols of the first response group;
(d) performing interference construction on the estimated data symbols of the first response group;
(e) subtracting the constructed interference of step (d) from the received signal;
(f) performing a joint detection process on the result of step (e) using a second one of the channel impulse response groups to provide estimated data symbols of the second response group;
(g) performing interference construction on the estimated data symbols of the second response group;
(h) subtracting the constructed interference of step (g) from the result of step (e); and
(i) combining the estimated data symbols of the first and second response groups.

2. The method of claim 1 wherein a joint detection process is performed on each of the channel impulse response groups in order of the power magnitude of the response groups.

3. The method of claim 1 wherein a joint detection process is performed on each of the channel impulse response groups while ignoring channel impulse responses of any of the response groups for which a joint detection process has not yet been performed.

4. The method of claim 1 further comprising:
(j) repeating steps (f), (g) and (h) for each remaining response group.

5. The method of claim 1 wherein step (d) further comprises:
(d1) spreading the estimated data symbols of the first response group with associated spreading codes for all codes to generate spread sequences;
(d2) adding the spread sequences of step (d1) to generate a composite chip sequence; and
(d3) convoluting the composite chip sequence of step (d2) with the first response group.

6. The method of claim 5 wherein step (g) further comprises:
(g1) spreading the estimated data symbols of the second response group with associated spreading codes for all codes to generate spread sequences;
(g2) adding the spread sequences of step (g1) to generate a composite chip sequence; and
(g3) convoluting the composite chip sequence of step (g2) with the second response group.

7. The method of claim 1 wherein the estimated data symbols of the first response group are soft symbols, the method further comprising:
(j) performing a hard decision process on the estimated data symbols of the first response group to provide hard estimated data symbols of the first response group, wherein the interference construction of step (d) is performed on the hard estimated data symbols of the first response group.

8. The method of claim 7 wherein the estimated data symbols of the second response group are soft symbols, the method further comprising:
(k) performing a hard decision process on the estimated data symbols of the second response group to provide hard estimated data symbols of the second response group, wherein the interference construction of step (g) is performed on the hard estimated data symbols of the second response group.

9. A code division multiple access (CDMA) system for performing multi-user detection (MUD) using reduced length channel impulse responses, the system comprising:
(a) a system response matrix having an original channel impulse response with a long delay spread, wherein the original channel impulse response is divided into a plurality of reduced length channel impulse response groups;
(b) means for receiving a signal to be processed;
(c) a first joint detector for performing a joint detection process on the received signal using a first one of the channel impulse response groups to provide estimated data symbols of the first response group;
(d) a first interference construction device for performing interference construction on the estimated data symbols of the first response group;
(e) a first adder for providing a first output signal by subtracting the constructed interference, performed on the estimated data symbols of the first response group, from the received signal;
(f) a second joint detector for performing a joint detection process on the first output signal using a second one of the channel impulse response groups to provide estimated data symbols of the second response group;
(g) a second interference construction device for performing interference construction on the estimated data symbols of the second response group;
(h) a second adder for providing a second output signal by subtracting the constructed interference, performed on the estimated data symbols of the second response group, from the first output signal; and
(i) a combiner for combining the estimated data symbols of the first and second response groups.

10. The system of claim 9 wherein a joint detection process is performed on each of the channel impulse response groups in order of the power magnitude of the response groups.

11. The system of claim 9 wherein a joint detection process is performed on each of the channel impulse response groups while ignoring channel impulse responses of any of the response groups for which a joint detection process has not yet been performed.

12. The system of claim 9 wherein the first interference construction device comprises:
(d1) first means for spreading the estimated data symbols of the first response group with associated spreading codes for all codes to generate spread sequences;
(d2) first means for adding the spread sequences, generated by the first spreading means, to generate a composite chip sequence; and
(d3) first means for convoluting the composite chip sequence, generated by the first adding means, with the first response group.

13. The system of claim 12 wherein the second interference construction device comprises:
(g1) second means for spreading the estimated data symbols of the second response group with associated spreading codes for all codes to generate spread sequences;
(g2) second means for adding the spread sequences, generated by the second spreading means, to generate a composite chip sequence; and
(g3) second means for convoluting the composite chip sequence, generated by the second adding means, with the second response group.

14. The system of claim 9 wherein the estimated data symbols of the first response group are soft symbols, the system further comprising:
(j) a first hard decision device for performing a hard decision process on the estimated data symbols of the first response group to provide hard estimated data symbols of the first response group, wherein the first interference construction device performs interference construction on the hard estimated data symbols of the first response group.

15. The system of claim 14 wherein the estimated data symbols of the second response group are soft symbols, the system further comprising:
(k) a second hard decision device for performing a hard decision process on the estimated data symbols of the second response group to provide hard estimated data symbols of the second response group, wherein second interference construction device performs interference construction on the hard estimated data symbols of the second response group.

16. In a code division multiple access (CDMA) system, a multi-user detector for performing multi-user detection using reduced length channel impulse responses, the multi-user detector comprising:
(a) a system response matrix having an original channel impulse response with a long delay spread, wherein the original channel impulse response is divided into a plurality of reduced length channel impulse response groups;
(b) means for receiving a signal to be processed;
(c) a first joint detector for performing a joint detection process on the received signal using a first one of the channel impulse response groups to provide estimated data symbols of the first response group;
(d) a first interference construction device for performing interference construction on the estimated data symbols of the first response group;
(e) a first adder for providing a first output signal by subtracting the constructed interference, performed on the estimated data symbols of the first response group, from the received signal;
(f) a second joint detector for performing a joint detection process on the first output signal using a second one of the channel impulse response groups to provide estimated data symbols of the second response group;
(g) a second interference construction device for performing interference construction on the estimated data symbols of the second response group;
(h) a second adder for providing a second output signal by subtracting the constructed interference, performed on the estimated data symbols of the second response group, from the first output signal; and
(i) a combiner for combining the estimated data symbols of the first and second response groups.

17. The multi-user detector of claim 16 wherein a joint detection process is performed on each of the channel impulse response groups in order of the power magnitude of the response groups.

18. The multi-user detector of claim 16 wherein a joint detection process is performed on each of the channel impulse response groups while ignoring channel impulse responses of any of the response groups for which a joint detection process has not yet been performed.

19. The multi-user detector of claim 16 wherein the first interference construction device comprises:
(d1) first means for spreading the estimated data symbols of the first response group with associated spreading codes for all codes to generate spread sequences;
(d2) first means for adding the spread sequences, generated by the first spreading means, to generate a composite chip sequence; and
(d3) first means for convoluting the composite chip sequence, generated by the first adding means, with the first response group.

20. The multi-user detector of claim 19 wherein the second interference construction device comprises:
(g1) second means for spreading the estimated data symbols of the second response group with associated spreading codes for all codes to generate spread sequences;
(g2) second means for adding the spread sequences, generated by the second spreading means, to generate a composite chip sequence; and
(g3) second means for convoluting the composite chip sequence, generated by the second adding means, with the second response group.

21. The multi-user detector of claim 16 wherein the estimated data symbols of the first response group are soft symbols, the multi-user detector further comprising:
(j) a first hard decision device for performing a hard decision process on the estimated data symbols of the first response group to provide hard estimated data symbols of the first response group, wherein the first interference construction device performs interference construction on the hard estimated data symbols of the first response group.

22. The multi-user detector of claim 21 wherein the estimated data symbols of the second response group are soft symbols, the multi-user detector further comprising:
(k) a second hard decision device for performing a hard decision process on the estimated data symbols of the second response group to provide hard estimated data symbols of the second response group, wherein second interference construction device performs interference construction on the hard estimated data symbols of the second response group.

23. In a code division multiple access (CDMA) system, a wireless transmit/receive unit (WTRU) for performing multi-user detection using reduced length channel impulse responses, the WTRU comprising:
(a) a system response matrix having an original channel impulse response with a long delay spread, wherein the original channel impulse response is divided into a plurality of reduced length channel impulse response groups;
(b) means for receiving a signal to be processed;
(c) a first joint detector for performing a joint detection process on the received signal using a first one of the channel impulse response groups to provide estimated data symbols of the first response group;
(d) a first interference construction device for performing interference construction on the estimated data symbols of the first response group;
(e) a first adder for providing a first output signal by subtracting the constructed interference, performed on the estimated data symbols of the first response group, from the received signal;
(f) a second joint detector for performing a joint detection process on the first output signal using a second one of the channel impulse response groups to provide estimated data symbols of the second response group;
(g) a second interference construction device for performing interference construction on the estimated data symbols of the second response group;
(h) a second adder for providing a second output signal by subtracting the constructed interference, performed on the estimated data symbols of the second response group, from the first output signal; and
(i) a combiner for combining the estimated data symbols of the first and second response groups.

24. The WTRU of claim 23 wherein a joint detection process is performed on each of the channel impulse response groups in order of the power magnitude of the response groups.

25. The WTRU of claim 23 wherein a joint detection process is performed on each of the channel impulse response groups while ignoring channel impulse responses of any of the response groups for which a joint detection process has not yet been performed.

26. The WTRU of claim 23 wherein the first interference construction device comprises:
(d1) first means for spreading the estimated data symbols of the first response group with associated spreading codes for all codes to generate spread sequences;
(d2) first means for adding the spread sequences, generated by the first spreading means, to generate a composite chip sequence; and
(d3) first means for convoluting the composite chip sequence, generated by the first adding means, with the first response group.

27. The WTRU of claim 26 wherein the second interference construction device comprises:
(g1) second means for spreading the estimated data symbols of the second response group with associated spreading codes for all codes to generate spread sequences;
(g2) second means for adding the spread sequences, generated by the second spreading means, to generate a composite chip sequence; and
(g3) second means for convoluting the composite chip sequence, generated by the second adding means, with the second response group.

28. The WTRU of claim 23 wherein the estimated data symbols of the first response group are soft symbols, the WTRU further comprising:
(j) a first hard decision device for performing a hard decision process on the estimated data symbols of the first response group to provide hard estimated data symbols of the first response group, wherein the first interference construction device performs interference construction on the hard estimated data symbols of the first response group.

29. The WTRU of claim 28 wherein the estimated data symbols of the second response group are soft symbols, the WTRU further comprising:
(k) a second hard decision device for performing a hard decision process on the estimated data symbols of the second response group to provide hard estimated data symbols of the second response group, wherein second interference construction device performs interference construction on the hard estimated data symbols of the second response group.

30. In a code division multiple access (CDMA) system, a base station for performing multi-user detection using reduced length channel impulse responses, the base station comprising:
(a) a system response matrix having an original channel impulse response with a long delay spread, wherein the original channel impulse response is divided into a plurality of reduced length channel impulse response groups;
(b) means for receiving a signal to be processed;
(c) a first joint detector for performing a joint detection process on the received signal using a first one of the channel impulse response groups to provide estimated data symbols of the first response group;
(d) a first interference construction device for performing interference construction on the estimated data symbols of the first response group;
(e) a first adder for providing a first output signal by subtracting the constructed interference, performed on the estimated data symbols of the first response group, from the received signal;
(f) a second joint detector for performing a joint detection process on the first output signal using a second one of the channel impulse response groups to provide estimated data symbols of the second response group;
(g) a second interference construction device for performing interference construction on the estimated data symbols of the second response group;
(h) a second adder for providing a second output signal by subtracting the constructed interference, performed on the estimated data symbols of the second response group, from the first output signal; and
(i) a combiner for combining the estimated data symbols of the first and second response groups.

31. The base station of claim 30 wherein a joint detection process is performed on each of the channel impulse response groups in order of the power magnitude of the response groups.

32. The base station of claim 30 wherein a joint detection process is performed on each of the channel impulse response groups while ignoring channel impulse responses of any of the response groups for which a joint detection process has not yet been performed.

33. The base station of claim 30 wherein the first interference construction device comprises:
(d1) first means for spreading the estimated data symbols of the first response group with associated spreading codes for all codes to generate spread sequences;
(d2) first means for adding the spread sequences, generated by the first spreading means, to generate a composite chip sequence; and
(d3) first means for convoluting the composite chip sequence, generated by the first adding means, with the first response group.

34. The base station of claim 33 wherein the second interference construction device comprises:
(g1) second means for spreading the estimated data symbols of the second response group with associated spreading codes for all codes to generate spread sequences;
(g2) second means for adding the spread sequences, generated by the second spreading means, to generate a composite chip sequence; and
(g3) second means for convoluting the composite chip sequence, generated by the second adding means, with the second response group.

35. The base station of claim 23 wherein the estimated data symbols of the first response group are soft symbols, the base station further comprising:
(j) a first hard decision device for performing a hard decision process on the estimated data symbols of the first response group to provide hard estimated data symbols of the first response group, wherein the first interference construction device performs interference construction on the hard estimated data symbols of the first response group.

36. The base station of claim 35 wherein the estimated data symbols of the second response group are soft symbols, the base station further comprising:
(k) a second hard decision device for performing a hard decision process on the estimated data symbols of the second response group to provide hard estimated data symbols of the second response group, wherein second interference construction device performs interference construction on the hard estimated data symbols of the second response group.

37. In a code division multiple access (CDMA) system, an integrated circuit (IC) for performing multi-user detection (MUD) using reduced length channel impulse responses, the IC comprising:
(a) a system response matrix having an original channel impulse response with a long delay spread, wherein the original channel impulse response is divided into a plurality of reduced length channel impulse response groups;
(b) means for receiving a signal to be processed;
(c) a first joint detector for performing a joint detection process on the received signal using a first one of the channel impulse response groups to provide estimated data symbols of the first response group;
(d) a first interference construction device for performing interference construction on the estimated data symbols of the first response group;
(e) a first adder for providing a first output signal by subtracting the constructed interference, performed on the estimated data symbols of the first response group, from the received signal;
(f) a second joint detector for performing a joint detection process on the first output signal using a second one of the channel impulse response groups to provide estimated data symbols of the second response group;
(g) a second interference construction device for performing interference construction on the estimated data symbols of the second response group;
(h) a second adder for providing a second output signal by subtracting the constructed interference, performed on the estimated data symbols of the second response group, from the first output signal; and
(i) a combiner for combining the estimated data symbols of the first and second response groups.

38. The IC of claim 37 wherein a joint detection process is performed on each of the channel impulse response groups in order of the power magnitude of the response groups.

39. The IC of claim 37 wherein a joint detection process is performed on each of the channel impulse response groups while ignoring channel impulse responses of any of the response groups for which a joint detection process has not yet been performed.

40. The IC of claim 37 wherein the first interference construction device comprises:
(d1) first means for spreading the estimated data symbols of the first response group with associated spreading codes for all codes to generate spread sequences;
(d2) first means for adding the spread sequences, generated by the first spreading means, to generate a composite chip sequence; and
(d3) first means for convoluting the composite chip sequence, generated by the first adding means, with the first response group.

41. The IC of claim 40 wherein the second interference construction device comprises:
(g1) second means for spreading the estimated data symbols of the second response group with associated spreading codes for all codes to generate spread sequences;
(g2) second means for adding the spread sequences, generated by the second spreading means, to generate a composite chip sequence; and
(g3) second means for convoluting the composite chip sequence, generated by the second adding means, with the second response group.

42. The IC of claim 37 wherein the estimated data symbols of the first response group are soft symbols, the IC further comprising:
(j) a first hard decision device for performing a hard decision process on the estimated data symbols of the first response group to provide hard estimated data symbols of the first response group, wherein the first interference construction device performs interference construction on the hard estimated data symbols of the first response group.

43. The IC of claim 42 wherein the estimated data symbols of the second response group are soft symbols, the IC further comprising:
(k) a second hard decision device for performing a hard decision process on the estimated data symbols of the second response group to provide hard estimated data symbols of the second response group, wherein second interference construction device performs interference construction on the hard estimated data symbols of the second response group.
